(19) United States
(12) Patent Application Publication
(10) Pub. No.: US 2022/0272945 A1
(43) Pub. Date: Sep. 1, 2022

(54) PET TOY

(71) Applicant: Doskocil Manufacturing Company, Inc., Arlington, TX (US)

(72) Inventors: Jill JACKSON, Fort Worth, TX (US); Ronald BAGLEY, Dallas, TX (US); Sunil PINTO, Arlington, TX (US); Josiah WILHELM, Fort Worth, TX (US)

(21) Appl. No.: 17/487,543

(22) Filed: Sep. 28, 2021

Related U.S. Application Data
(60) Provisional application No. 63/154,206, filed on Feb. 26, 2021.

(51) Int. Cl. A01K 15/02

(52) U.S. Cl. CPC A01K 15/026

(57) ABSTRACT

A pet toy includes a curved part and a longitudinal part. The curved part has a first end portion, a second end portion and an arch. The arch connects the first and second end portions. The longitudinal part is attached to the first and second end portions. The longitudinal part is spaced from the arch so that the longitudinal part forms a arcuate shape with the curved part.

### CROSS-REFERENCE TO RELATED APPLICATIONS

This application claims priority to Provisional U.S. Patent Application No. 63/154,206, filed on Feb. 26, 2021. The entire disclosure of Provisional U.S. Patent Application No. 63/154,206 is hereby incorporated by reference.

### BACKGROUND

### Field of the Invention

The present invention generally relates to a pet toy. More specifically, the present invention relates to a pet toy that is a chew toy.

### Background Information

It is estimated that over two-thirds of dogs over the age of three have periodontal disease, an inflammation or infection of the tissues surrounding the teeth. Periodontal disease starts as gingivitis caused by plaque and often progresses to involve the bony tooth sockets. Left untreated, periodontal disease can lead to painful tooth loss. Veterinarians recommend brushing dogs' teeth daily to prevent infections and gum disease. Some conventional chew toys are designed as toothbrush replacements and attempt to maintain a dog's interest long enough for their teeth to be cleaned and for ease of cleaning after use.

### SUMMARY

It has been determined that brushing a dog's teeth may be tedious and dangerous if a dog is not agreeable. In view of the state of the known technology, a first aspect of the present disclosure is to provide a pet toy comprising a curved part and a longitudinal part. The curved part having a first end portion, a second end portion and an arch. The arch connects the first and second end portions. The longitudinal part is attached to the first and second end portions. The longitudinal part is spaced from the arch so that the longitudinal part forms a arcuate shape with the curved part.

In a second aspect of the pet toy in accordance with the first aspect, the curved part is made of a first material and the longitudinal part is made of a second material, the second material is more flexible than the first material.

In a third aspect of the pet toy in accordance with the second aspect, the curved part is made of rubber.

In a fourth aspect of the pet toy in accordance with the third aspect, the longitudinal part is a rope.

In a fifth aspect of the pet toy in accordance with the fourth aspect, the first and second end portions of the curved part are over-molded to the longitudinal part.

In a sixth aspect of the pet toy in accordance with the first aspect, the arch includes at least one opening leading to at least one pocket having a bottom surface on the curved part.

In a seventh aspect of the pet toy in accordance with the sixth aspect, the at least one opening is a slot having a longitudinal length extending across a thickness of the arch.

In an eighth aspect of the pet toy in accordance with the seventh aspect, the at least one opening includes a plurality of openings, each of the plurality of openings leads to a corresponding pocket of the at least one pocket.

In a ninth aspect of the pet toy in accordance with the sixth aspect, the curved part includes a plurality of first abutments disposed between the at least one opening and the first end portion.

In a tenth aspect of the pet toy in accordance with the ninth aspect, the curved part includes a plurality of second abutments disposed between the at least one opening and the second end portion.

In an eleventh aspect of the pet toy in accordance with the sixth aspect, the curved part includes an outer surface, an inside surface and a pair of side surfaces that connect the outer and inside surfaces, the inside surface facing the longitudinal part.

In a twelfth aspect of the pet toy in accordance with the eleventh aspect, the at least one opening are disposed on the outer surface.

In a twelfth aspect of the pet toy in accordance with the eleventh aspect, the at least one opening are disposed on the outer surface.

In a thirteenth aspect of the pet toy in accordance with the twelfth aspect, the arch further includes a plurality of debossings that are disposed adjacent to the at least one opening.

In a fourteenth aspect of the pet toy in accordance with the thirteenth aspect, the plurality of debossings includes a plurality of first debossings that extend across the outer surface into the pair of side surfaces.

In a fifteenth aspect of the pet toy in accordance with the fourteenth aspect, the plurality of debossings further include a plurality of second debossings that are disposed on the side surfaces.

In a sixteenth aspect of the pet toy in accordance with the fifteenth aspect, the plurality of debossings further include a plurality of third debossings disposed on the inside surface.

In a seventeenth aspect of the pet toy in accordance with the sixteenth aspect, the first, second and third debossings have hexagon-shaped borders.

In an eighteenth aspect of the pet toy a method of making a pet toy comprises molding vulcanized rubber to form a curved part. The curved part has a first end portion, a second end portion. The curved part has an arch connecting the first and second end portions. The method further comprises debossing the surface of the curved part to have a plurality of indents. The method further comprises over-molding first and second ends of the curved part to a longitudinal part. The longitudinal part is spaced from the arch so that the longitudinal part forms a arcuate shape with the curved part.

Embodiments of the invention described herein provide a suitable alternative to a tooth brush for cleaning a dog's tooth. Embodiments of the present invention have a unique structure and configuration to not only clean teeth but to maintain a dog's interest long enough for their teeth to be cleaned and for ease of cleaning after use.

### BRIEF DESCRIPTION OF THE DRAWINGS

Referring now to the attached drawings which form a part of this original disclosure:

FIG. 1 is a top perspective view of a pet toy in accordance with an illustrated embodiment;

FIG. 2 is a bottom perspective view of the pet toy of FIG. 1;

FIG. 3 is a top elevational view of the pet toy of FIGS. 1 and 2;

FIG. 4 is a bottom elevational view of the pet toy of FIGS. 1 to 3;

FIG. 5 is a side elevational view of the pet toy of FIGS. 1 to 4;

FIG. 6 is an end elevational view of the pet toy of FIGS. 1 to 5;

FIG. 7 is a cross-sectional view of the pet toy of FIGS. 1 to 6;

FIG. 8 is a side perspective view of the pet toy of FIGS. 1 to 7;

FIG. 9 is a top elevational view of the pet toy of FIGS. 1 to 8 with the pet toy in a deformed state.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

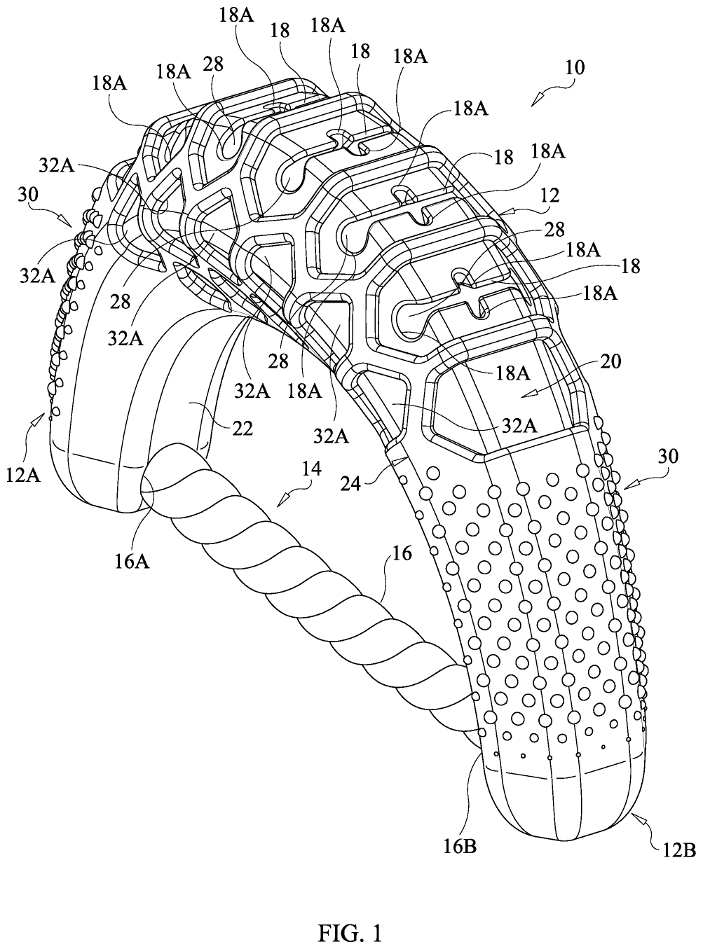

Referring initially to FIG. 1, a pet toy 10 is illustrated in accordance with an illustrated embodiment. The pet toy 10 is a chew toy that comprises a curved part 12 and a longitudinal part 14. The longitudinal part 14 is an elongated part having a length that is greater than its width. The curved part 12 has a first end portion 12A, a second end portion 12B and an arc shape (hereinafter arch 12) connecting the first and second end portions 12A and 12B. The curved part 12 defines a main body of the pet toy 10. In the illustrated embodiment, the longitudinal part 14 is a rope 16. In the illustrated embodiment, the curved part 12 is made of rubber that is molded to have an arcuate shape. The curved part 12 can alternatively be made of silicone.

Therefore, in the illustrated embodiment, the curved part 12 is made of a first material (e.g., rubber) and the longitudinal part 14 is made of a second material (e.g., rope 16 or fabric). The second material is more flexible than the first material. The curved part 12 and the longitudinal part 14 together comprise a flexible, deformable pet toy 10 that can be chewed by a pet for prolonged engagement. In the illustrated embodiment, the curved part 12 is a six-sided rubber arch, as will be further described below. The curved part 12 is preferably designed to substantially mimic the appearance of a banana in the illustrated embodiment.

In particular, the pet toy 10 enables cleaning of a pet's teeth and/or gums during use of the pet toy 10. That is, the pet toy 10 can be an alternative to toothbrushes for pets, and is further designed and configured to maintain the pet's interest for a longer duration so that the teeth can be cleaned more thoroughly. Therefore, the pet toy 10 is a textured toy with abutments, protrusions, nubs and raised surfaces for rubbing against a dog's teeth to clean the teeth. Further, the pet toy 10 includes one or more openings 18 for storing toothpaste that can be extracted or ooze from the openings 18 when the dog chews or plays with the pet toy 10. The openings 18 are also designed for easy cleaning.

Referring to FIGS. 1, 2 and 7, the rope 16 is attached to the first and second end portions 12A and 12B of the rubber arch 12. That is, the rope 16 includes a first end 16A that is fixed to the first end portion 12A of the rubber arch 12. The rope 16 includes a second end 16B that is fixed to the second end portion 12B of the rubber arch 12. The rope 16 is spaced from the arch 12 so that the rope 16 forms a arcuate shape with the rubber arch 12. Therefore, the overall shape of the pet toy 10 has a arcuate shape as defined by the rubber arch 12 and the rope 16.

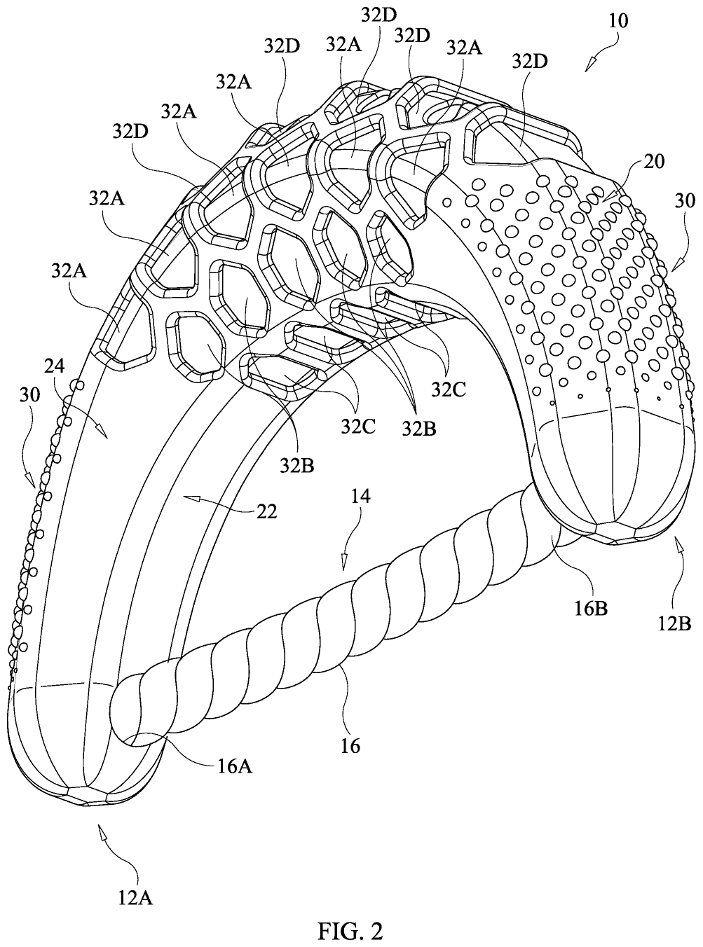

The rope 16 is preferably made of polypropylene that is durable but resilient. As seen in FIG. 2, the rope 16 allows the rubber arch 12 to bend or deform during use. In the illustrated embodiment, the rope 16 serves as an additional chewing texture to the rubber arch 12. The rubber arch 12 is preferably made of a durable and resilient material that is also deformable and has elastic properties so that it retains its shape and overall structure during use. In the illustrated embodiment, the rubber arch 12 is preferably made of vulcanized rubber.

The differing textures between the rope 16 and the rubber arch 12 helps the pet maintain interest in the pet toy 10 during use. The curved shape of the rubber arch 12 incentivizes dogs to rock, roll, and flip the pet toy 10 around. Pets can also use the rope 16 to maneuver and position the toy into different chewing positions.

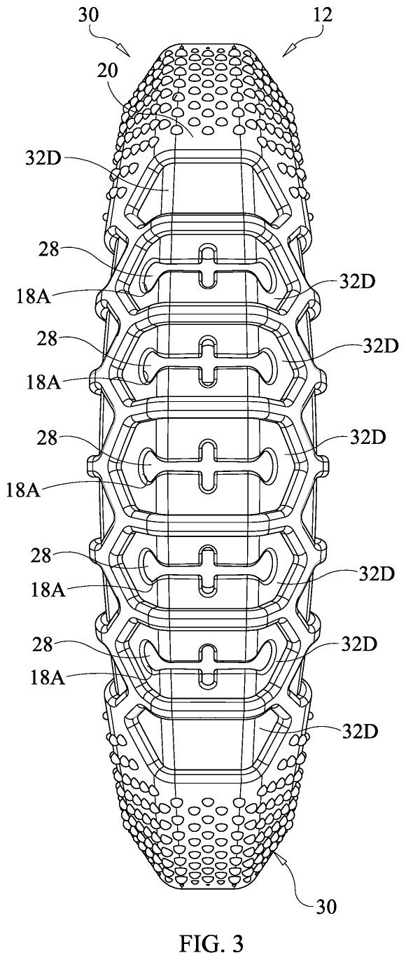

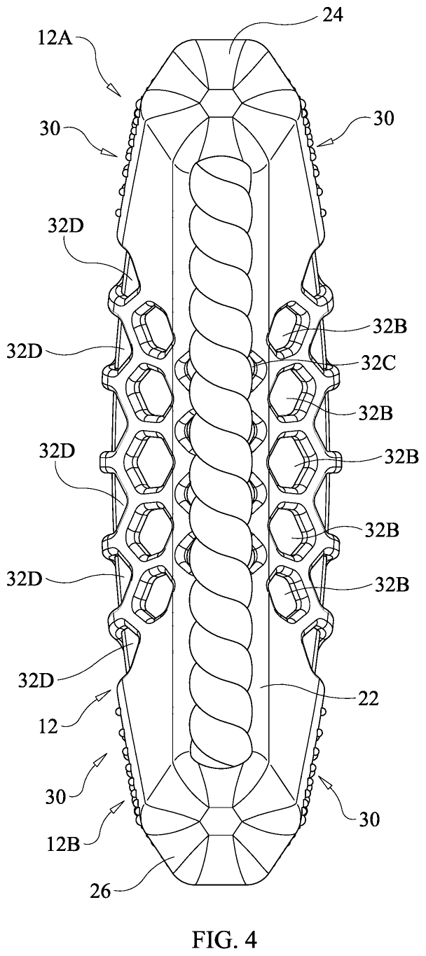

Referring to FIGS. 1 to 4, the rubber arch 12 includes six surfaces that curve into one another. That is, the rubber arch 12 includes an outer surface 20 (best seen in FIG. 3) and an inside surface 22 (best seen in FIG. 4). The rubber arch 12 further includes pair of side surfaces 24 connecting the outer surface 20 and inside surface 22 (best seen in FIGS. 1, 2 and 5). The rubber arch 12 further includes pair of end surfaces 26 at the first and second end portions 12A and 12B, as seen in FIG. 4 As shown in FIG. 1, the inside surface 22 of the rubber arch 12 faces the rope 16. The rope 16 is attached to the first and second end portions 12A and 12B at a location adjacent to the end surfaces 26.

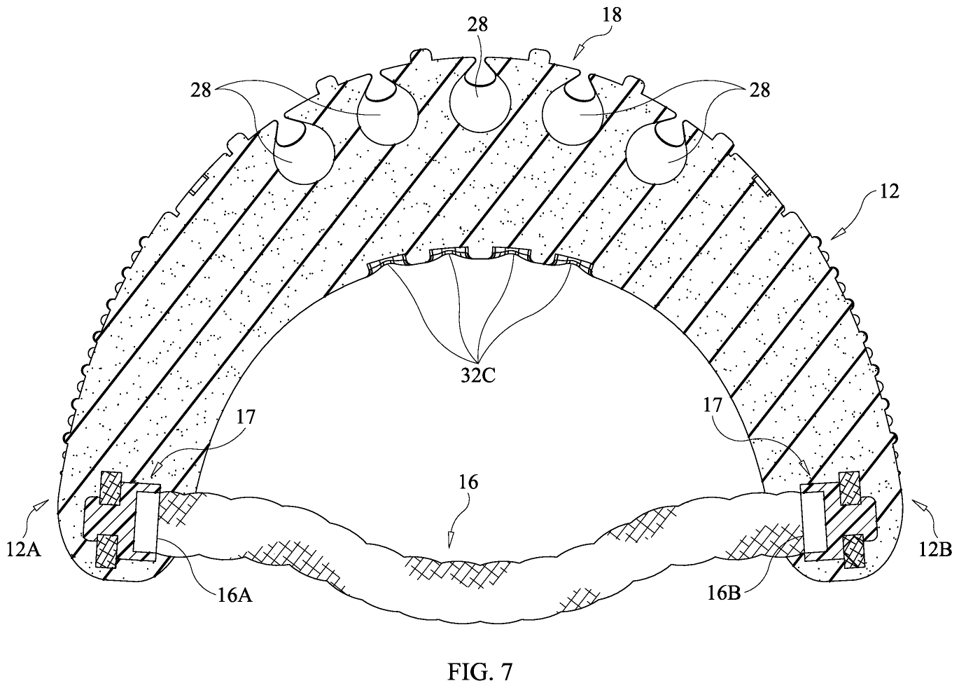

As best seen in FIG. 7, the first and second end portions 12A and 12B of the rubber arch 12 are over-molded to the rope 16. That is, the first and second ends 16A and 16B of the rope 16 are attached to an interior portion of the first and second end portions 12A and 12B. In this way, the rubber arch 12 is over-molded to the rope 16 at the first and second end portions 12A and 12B of the curved part 12. The first and second ends 16A and 16B of the rope 16 define a pair of j oints 17 for the rope 16 with respect to the rubber arch 12. The pet toy 10 further includes fasteners F for securing the joints 17 to the rubber arch 12. Preferably, the pet toy 10 includes nylon fasteners F that secure the ends 16A and 16B of the rope 16 where the first and second end portions 12A and 12B of the rubber arch 12 are over-molded to the rope 16.

As best seen in FIGS. 3 and 4, the rubber arch 12 includes at least one opening 18 leading to at least one pocket 28. The at least one pocket 28 has a bottom surface on the curved part 12. Preferably, the at least one opening includes a plurality of openings 18 that leads to respective ones of the bottom surfaces. The bottom surfaces are rounded, as seen in FIG. 7. That is, the rubber arch 12 includes the plurality of openings 18. Each of the plurality of openings 18 leads to a corresponding pocket 28 of the at least one pocket 28, each having bottom surfaces.

Therefore, the rubber arch 12 includes a plurality of pockets 28 that correspond to the openings 18. The openings 18 are disposed on the outer surface 20, as seen in FIGS. 1 and 3. In the illustrated embodiment, the rubber arch 12 includes five openings 18 leading to five pockets 28. However, it will be apparent to those skilled in the pet products field from this disclosure that the pet product can include different numbers of openings 18 and pockets 28 as desired and/or necessary.

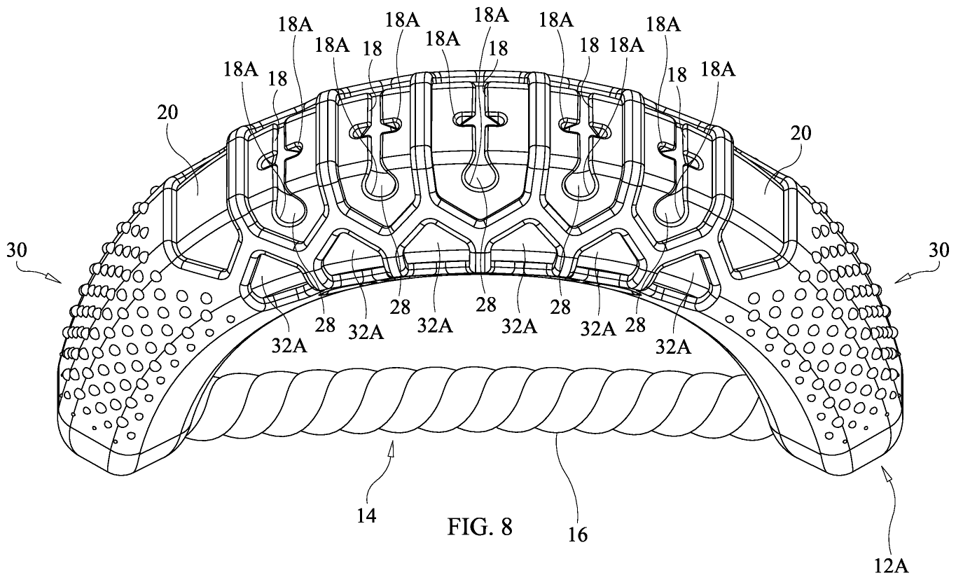

As best seen in FIGS. 4, 5, 8 and 14, the openings 18 of the illustrated embodiment are preferably shaped to be slots. That is, the openings 18 are preferably elongated. As shown, the openings 18 have a longitudinal length extending across a thickness of the arch 12. Alternatively speaking, the openings 18 extend across the outer surface 20 into the pair of side surfaces 24 of the rubber arch 12. As best seen in FIGS. 12 and 14, the openings 18 have rounded borders at the side surfaces 24 that lead to the pockets 28. Therefore, the openings 18 are arranged successively along a top of the rubber arch 12 to help create an intriguing treat puzzle for pets so that pets will engage the pet toy 10 to discover how to open the pockets 28.

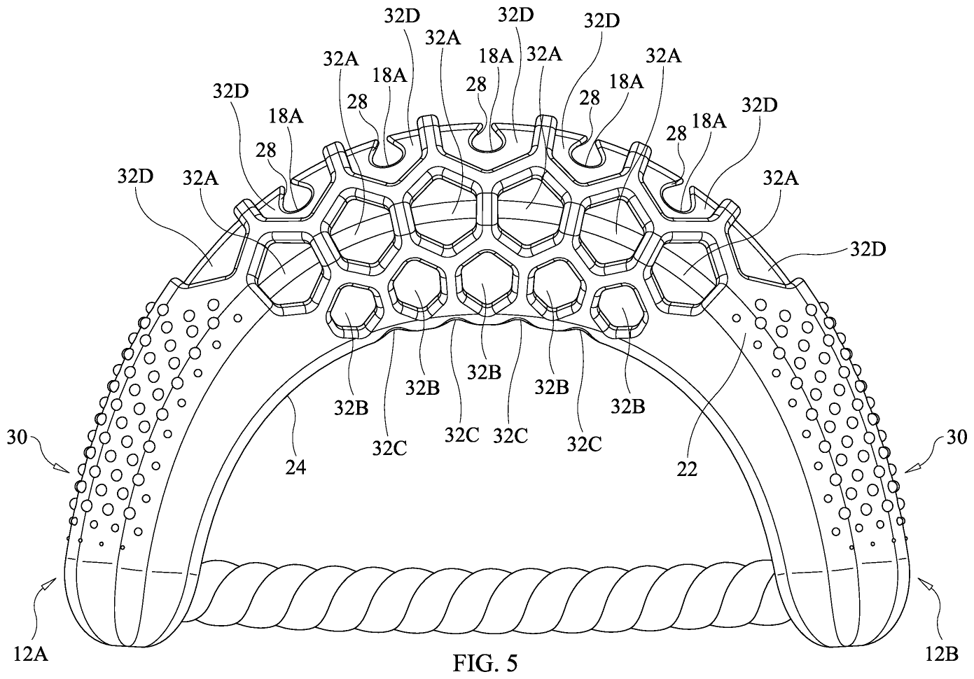

In the illustrated embodiment, the pockets 28 are configured to contain cleaning agents, such as toothpaste and/or food and treats. When the pet engages with the pet toy 10, the rubber arch 12 can bend or deform to access the cleaning agents and/or foodstuffs in the pockets 28, as best seen in FIGS. 4 and 5. It will be apparent to those skilled in the pet products field from this disclosure that the openings 18 and pockets 28 can have different shapes and sizes as desired and/or necessary to contain agents and foodstuffs.

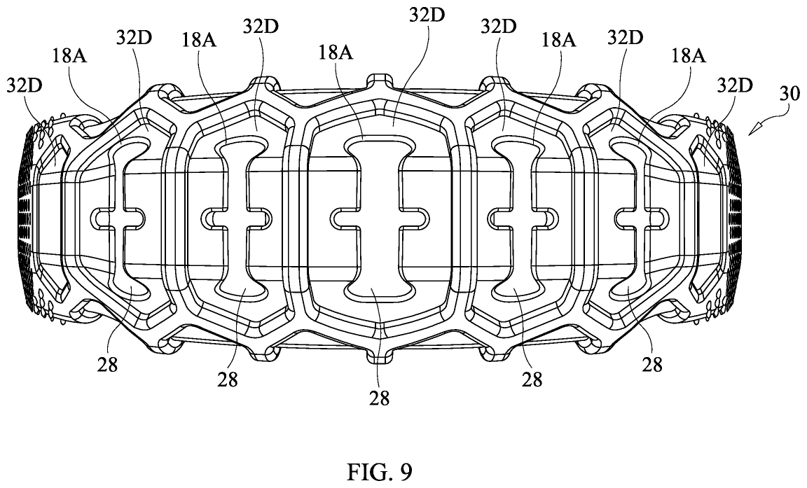

Thus, in the illustrated embodiment, the pockets 28 are hidden pockets 28 when the rubber arch 12 is in an unbent (undeformed) condition, as seen in FIG. 1. In the unbent condition, the pet can still smell any cleaning agents and/or foodstuffs contained in the pockets 28. The pockets 28 are more accessible in a bent (deformed) condition of the rubber arch 12 to reveal cleaning agents and/or foodstuffs, as seen in FIG. 9. With this arrangement, the pet toy 10 can also deform or bend to clean the pockets 28 and the openings 18.

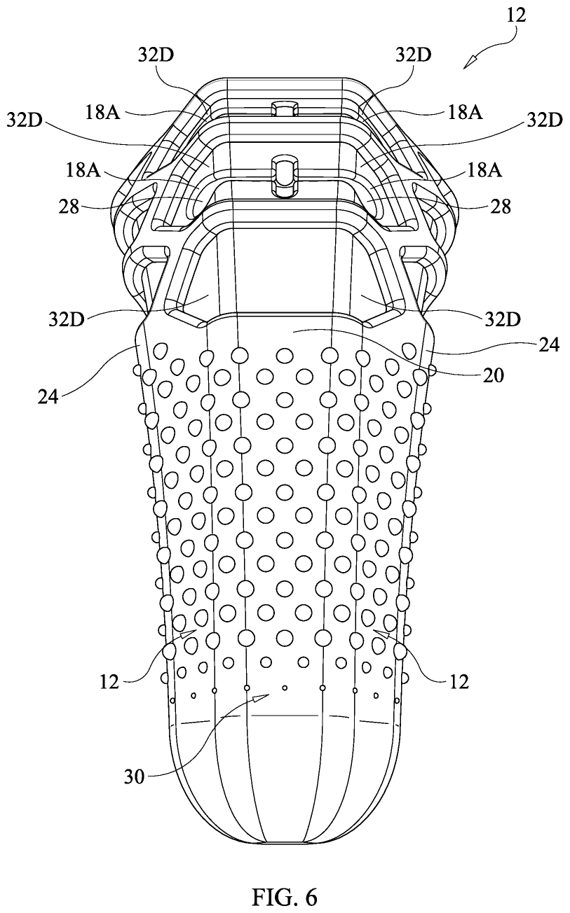

As best seen in FIGS. 1, 2, 5 and 6, the rubber arch 12 further includes a plurality of abutments 30. In particular, the rubber arch 12 includes a plurality of first abutments 30A disposed between the openings 18 and the first end portion 12A. The rubber arch 12 includes a plurality of second abutments 30B disposed between the openings 18 and the second end portion 12B. The abutments 30 are raised nubs on the rubber arch 12 that are designed to rub against the pet's teeth and gums to help clean the teeth and gums. The abutments 30 preferably have rounded surfaces.

The rubber arch 12 further includes a plurality of debossings 32 (e.g., indents). Therefore, the rubber arch 12 is made to have messages or patterns that are sunken into the surface of the rubber arch 12 through the use of a mold. The rubber arch 12 is debossed in a conventional manner. As seen in FIGS. 1, 2 and 5, the rubber arch 12 includes a plurality of first debossings 32A. Each of the first debossings 32A are disposed around one of the openings 18. Therefore, the first debossings 32A extend across the outer surface 20 into the pair of side surfaces 24, as seen in FIG. 1.

Referring to FIGS. 2 and 5, the rubber arch 12 further includes a plurality of second debossings 32B on the side surfaces 24. The rubber arch 12 further includes a plurality of third debossings 32C disposed on the inside surface 22, as best seen in FIG. 2. The first, second and third debossings 32A, 32B and 32C have hexagon-shaped borders that are raised surfaces in the illustrated embodiment. However, it will be apparent to those skilled in the pet products field from this disclosure that all of the debossings 32 can have different and/or varying shapes and sizes.

In the illustrated embodiment, the openings 18 are also positioned within in fourth debossings 32D having raised borders. In particular, the raised borders for the fourth debossings 32D are hexagon shaped. Therefore, each of the openings 18 are surrounded by a hexagon-shaped border that is a raised surface. However, it will be apparent to those skilled in the pet products field from this disclosure that all of the debossings 32 can have different and/or varying shapes and sizes.

The debossings 32 and the abutments 30 of the rubber arch 12 help create friction with the pet when the pet engages the pet toy 10. That is, the debossings and abutments 30 help create the pet toy 10 having varying surfaces and textures to help enhance the pet's engagement with the pet toy 10.

As described herein embodiments of the invention provide a suitable alternative to a tooth brush for cleaning a dog's tooth. Moreover, as can be understood, embodiments of the present invention have a unique structure and configuration to not only clean teeth but to maintain a dog's interest long enough for their teeth to be cleaned and for ease of cleaning after use.

### GENERAL INTERPRETATION OF TERMS

In understanding the scope of the present invention, the term “comprising” and its derivatives, as used herein, are intended to be open ended terms that specify the presence of the stated features, elements, components, groups and/or steps, but do not exclude the presence of other unstated features, elements, components, groups and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet toy comprising:
a curved part having a first end portion, a second end portion, and an arch connecting the first and second end portions; and
a longitudinal part attached to the first and second end portions, the longitudinal part being spaced from the arch so that the longitudinal part forms an arcuate shape with the curved part.

2. The pet toy according to claim 1, wherein
the curved part is made of a first material and the longitudinal part is made of a second material, the second material being more flexible than the first material.

3. The pet toy according to claim 2, wherein
the curved part is made of rubber.

4. The pet toy according to claim 3, wherein
the longitudinal part is a rope.

5. The pet toy according to claim 4, wherein
the first and second end portions of the curved part are over-molded to the longitudinal part.

6. The pet toy according to claim 1, wherein
the arch includes at least one opening leading to at least one pocket having a bottom surface on the curved part.

7. The pet toy according to claim 6, wherein
the at least one opening is a slot having a longitudinal length extending across a thickness of the arch.

8. The pet toy according to claim 7, wherein
the at least one opening includes a plurality of openings, each of the plurality of openings leads to a corresponding pocket of the at least one pocket.

9. The pet toy according to claim 6, wherein
the curved part includes a plurality of first abutments disposed between the at least one opening and the first end portion.

10. The pet toy according to claim 9, wherein
the curved part includes a plurality of second abutments disposed between the at least one opening and the second end portion.

11. The pet toy according to claim 6, wherein
the curved part includes an outer surface, an inside surface and a pair of side surfaces that connect the outer and inside surfaces, the inside surface facing the longitudinal part.

12. The pet toy according to claim 11, wherein
the at least one opening are disposed on the outer surface.

13. The pet toy according to claim 12, wherein
the arch further includes a plurality of debossings that are disposed adjacent to the at least one opening.

14. The pet toy according to claim 13, wherein
the plurality of debossings includes a plurality of first debossings that extend across the outer surface into the pair of side surfaces.

15. The pet toy according to claim 14, wherein
the plurality of debossings further include a plurality of second debossings that are disposed on the side surfaces.

16. The pet toy according to claim 15, wherein
the plurality of debossings further include a plurality of third debossings disposed on the inside surface.

17. The pet toy according to claim 16, wherein
the first, second and third debossings have hexagon-shaped borders.

18. A method of making a pet toy comprising:
molding vulcanized rubber to form a curved part having a first end portion, a second end portion, and an arch connecting the first and second end portions;
debossing the surface of the curved part to have a plurality of indents; and
overmolding first and second ends of the curved part to a longitudinal part, the longitudinal part being spaced from the arch so that the longitudinal part forms a arcuate shape with the curved part.
